(19) United States
(12) Patent Application Publication
(10) Pub. No.: US 2004/0070847 A1
(43) Pub. Date: Apr. 15, 2004

(54) Determining points of disturbance

(76) Inventors: Werner Hartmeier, Effretikon (CH); Bernhard Furrer, Winterthur (CH); Reto Schonbachler, Uhwiesen/Zh (CH)

Correspondence Address: Stephan E. Bondura, Dority & Manning, Attorneys at Law, P.A., P.O. Box 1449, Greenville, SC, 29602, US

(21) Appl. No.: 09/990,867

(22) Filed: Nov. 16, 2001

(30) Foreign Application Priority Data
Nov. 16, 2000 (DE) 100 57 170.0

(51) Int. Cl. G02B 27/02

(52) U.S. Cl. 359/798

(57) ABSTRACT

A method and system are provided for determining points of disturbances in a fibrous planar structure. The planar structure is conveyed past a receiver having an array of photodiodes. The photodiodes determine the brightness of the planar structure and compares the received brightness value to threshold values. Brightness values in excess of a predetermined threshold value are deemed to be disturbances in the fibrous planar surface.

The invention concerns a method and a device for determining points of disturbance in planar structures according to the preamble of the claims 1 and 20.

The CH 669,401 A5 describes a nep sensor at a doffer of a card. The sensor comprises a housing, which essentially extends over the work width of the machine, whereby the housing is provided with windows by which single photo sensors can monitor the doffer surface. These photo sensors supply one output signal each which changes in terms of a function of time depending on the changing light intensity entering the respective photo sensor. The evaluation is laid out in such a way that the continuous signal of each photo sensor can be evaluated. In that a specific geometry of the arrangement is selected monitoring of the clothing points is to be avoided since they could contribute to the falsification of the results. In the preferred embodiment not only the light intensity but rather the differential quotient of the intensity change should be considered during evaluation of the obtained signals. There is also an embodiment provided in which the single sensors are arranged in groups whereby the sensor arrangement can be moved transverse to the conveying direction of the web by a drive means.

From the WO 99/50486 a web control device is known, where opto-electronic equipment is enclosed in a housing, which can monitor a pre-determined spot of a planar structure. Likewise with the application of a source of light the spot is subjected to light which is reflected and evaluated in optical means with respect to its intensity. The intensity of the reflected light depends on the condition of the fibre web which is momentarily within the zone of the observed spot. If the observed fibre web is bright or if it exhibits bright zones then more light is reflected than if the observed web is darker. Neps, which consist of an accumulation of fibres, thus appear to the optical means as a bright zone and in accordance with the WO 99/50486 are determined as a point of disturbance. The number of determined points of disturbance is evaluated and with the result a conclusion on the quality of the fibre web is made, even if only small zones of the entire web were actually monitored.

With both known methods and devices it turned out that by this design substantially more points of disturbance were detected than were actually present.

Thus the task as an object of the present invention is to avoid the disadvantage specified above and to provide a correct measure for the evaluation of the quality of the planar structure, in particular of a fibre web.

The task is solved by a method with the characteristic features of claim 1. The planar structures, which are examined by the method according to the invention to determine points of disturbance, consist in particular of fibres and are for example being produced on cards. A respective inspection of the planar structure can take place, however, also for example in drawing means in which the fibre webs are being spread-out to form a planar structure. In the method according to the invention for determining points of disturbance the brightness of the planar structure is recognized by means of at least one signal receiver furnished with photodiodes arranged linearly thereon. Brightness values above a pre-determined threshold value are recognized as points of disturbance. New and inventive is that the planar structure is being moved in relation to the signal receiver and that thereby the surface-size extent of the brightness value, being above the pre-determined threshold value, is being determined. Thereby it is possible, according to the invention, to determine, based on the extension of the brightness differences, whether there actually is a real point of disturbance or whether there is a maybe only naturally occurring, and therefore also acceptable, brightness difference in the planar structure. These natural brightness differences in the fibre web do not point-out disturbances within the machine producing the planar structure and are thus no indication for an excessive wear of single components of the machine, as is the case with neps and foreign particles. If such brightness differences were also included in the counting of the smaller surfaces with larger brightness, then a wrong evaluation of the wear condition of the machine would take place and maintenance of the machine would take place at a time when that maintenance is not yet necessary. With the present invention it is thus possible to schedule the maintenance work on the machine exactly at a time when a wear of single components actually has occurred. Thus, the maintenance intervals can become longer and thereby the cost of maintenance can be reduced.

Beyond that, due to avoidable standstills of the machine its productivity is increased.

Advantageously classifying the point of disturbance is being performed on the basis of the number of responding diodes and/or the response duration of the diodes. If classifying of the points of disturbance is accomplished on the basis of these criteria, then a distinction between large and small-area points of disturbance is possible. From what size on such a point of disturbance is to be considered a permissible point of disturbance and/or a permissible brightness difference depends on the desired quality of the planar structure as well as on the planar structure itself, i.e., which point of disturbance, for example, is actually to be evaluated as a nep and can differ from application to application.

Advantageously a small surface is recognized as an actual particle of disturbance and a large surface as permissible brightness fluctuation within the planar structure. Such brightness fluctuations arise in a fibre web for example by the fact that already slight thickness differences of the fibre web lead to a higher light reflectance of the planar structure. This higher reflectance can be registered as increasing brightness. The invention has recognized that thickness differences in the planar structure, which lead to a higher reflectance, also even generate, like an actual particle of disturbance, an increasing brightness at the photodiodes. An additional criterion according to which the distinction between thickness fluctuation and actual point of disturbance can take place prevails however, in the fact that the permissible thickness fluctuation of the fibre web usually extends over a larger surface than an actual particle of disturbance. In an advantageous embodiment according to the invention it is therefore suggested that only brightness fluctuations with small sized surfaces are being registered as particles of disturbance and that brightness fluctuations which arise on a large surface are registered as permissible thickness fluctuation of the fibre web. Thereby it was possible to come to a substantially closer-to-reality statement about the wear condition of the machine since the determination of the points of disturbance is substantially closer to the number of the actually present points of disturbance within the fibre web.

In order to determine whether a certain brightness value is higher in relation to the normal brightness value of the planar structure, an average value of the brightness of the planar structure is being determined. Depending on this average value a threshold value is specified. If the determined brightness is above this threshold value then, based on the photodiode, a signal is generated which indicates a fundamental point of disturbance.

It has proved particularly favourable if the determined average value is multiplied by a factor and in such a way serves as threshold value for the determination of the points of disturbance. Thereby fluctuations near the average value are accepted without resulting in an indication of a point of disturbance. As a factor, for example, a value between 1,2 and 1,5 has proved as particularly favourable with a fibre web of a card. This value can naturally be different depending on the kind of the planar structure, on the desired quality of the planar structure as well as on the used photodiodes and their sensitivity.

According to the invention it is suggested that the average value is derived from all diodes and that it is then averaged or integrated through the time. Thus a very reliable average value of the whole measuring head is obtained whereby the deviations from the average value and/or the therefrom calculated threshold value caused by the points of disturbance are registered particularly reliably.

Preferably the over-all voltage of the diode signals is used to derive the average value. This means that for the averaging not only the direct current portion of the diode signals are used, but also the complete signal. If the average value is derived over a time period which corresponds with a pre-determined distance, in particular about 5 mm of the planar structure, then, on the one hand the average value is formed exactly enough and on the other hand the average value follows the natural brightness fluctuations fast enough. Thus detection of the point of disturbance can also take place reliably in the case of strongly varying web density.

It has proved as particularly favourable that the time period for averaging is selected in dependence of the speed of the doffer. By this the accuracy of the average value is also increased. By the way of the above mentioned formation of the average value according to the invention it is possible to choose shorter time constants and thus the average value is adapted faster to large-surface brightness fluctuations, as they are generated, for example, by web clouds and/or thickness differences within the fibre web to be produced. This is favourable in that in bright and dark web portions the points of disturbances can be detected in a comparatively reliable way.

Preferably each single measuring signal of each photodiode is examined with regard to exceeding of the threshold value. Thereby it is possible to already detect very small points of disturbance, starting for example, from the size of 0.5 mm diameter. If the single photodiodes are essentially arranged without any gap, then a nearly complete monitoring of the examined spot is reached.

For the determination of the width of the point of disturbance the number of measuring signals, arranged next to each other, which exceed the threshold value at the same time, is determined. Thereby the complete width of the point of disturbance is registered. Thus each single signal is not just evaluated independently from the neighbour signal, but also an evaluation of the neighbouring signals takes place in order to make conclusions about the point of disturbance. The evaluation of neighbouring diodes is important for the determination of the surface of a coherent point of disturbance and for judging whether an actual point of disturbance prevails here or whether there is a large brightness difference, for example, a web cloud within the planar structure.

Besides the determination of the width of the point of disturbance, in a particularly favourable embodiment, the length of the point of disturbance can also be determined in that the speed by which the planar structure is moved past the measuring head and in that the time during which the threshold value is exceeded is being determined. By the multiplication the determined width and length of the point of disturbance, the surface of the point of disturbance is being calculated. Thereafter, depending on it, the decision can be made whether there is an actual point of disturbance or a general increase of the brightness in the planar structure as results for example from differences in the web thickness.

It has proved as particularly favourable that exceeding of a pre-determined surface, in particular 4 mm², is being rated as an acceptable point of disturbance in a fibre web. According to the experiences made with the invention a brightness difference, which exceeds 4 mm², cannot anymore be rated as a point of disturbance in the fibre web. Conventional points of disturbance are indeed smaller than 4 mm². It can therefore be concluded that this brightness increase did not develop due to an actual particle of disturbance, but that it is based on a web cloud.

In a particularly favourable embodiment of the invention provision is made that when exceeding occurs in at least one of the two far end measuring signals of photodiodes being arranged in line, then this is not rated as a point of disturbance. In order to avoid, according to the invention, the number of points of disturbance in the measuring device from appearing higher than the actual points of interference which are present in the planar structure, which are only statistically evaluated, only such points of disturbance are determined which were clearly recognized as actual points of disturbance. If the photodiodes positioned on the outer ends indicate a brightness increase, then it cannot be excluded that the brightness increase extends far beyond the measuring zone of the measuring head and thus is being obtained from a permittable large-surface brightness increase and not from a point of disturbance. In the preferred embodiment it is therefore specified, that, if the outer photodiode reacts, it is not necessarily because of an actual point of disturbance and that this is therefore not rated within that class of points of disturbance. By the method of counting only actual points of disturbance it is preferably avoided that the number of actual points of disturbance is being set too high. By the definition of a certain size of surface that is to be rated as particle of disturbance it is sometimes possible that such brightness increases are included in the counting, which actually do not represent a point of disturbance. By excluding, as described, the laterally arranged photodiodes from the counting certain compensation is established here, so that overall with the count of the number of actual points of disturbance a count very close-to-reality is made possible.

It has proved as favourable, if the signals of the signal receiver are amplified before the evaluation. Thereby a more accurate evaluation is possible with regard to whether the signal exceeds the threshold value or not.

If the planar structure within the zone to be measured, i.e. within the zone of the spot to be observed, is lit in particular from the side, then, by way of the photodiodes, a reliable signal registration is made possible. With the lateral light, in connection with the employment of rollers being furnished with clothing, it is furthermore avoided that the clothing points reflect the light in the direction of the photodiodes and thus produce an incorrect signal since the photodiode would indicate the reflection as small-area brightness increase of the fibre web.

In order to obtain a particularly high resolution of the examined zone it is favourable if the planar structure that is to be examined within the zone of the signal receiver is magnified optically. Thereby the photodiodes already respond to very small points of disturbance.

It is particularly favourable if, within the measuring device according to the invention, a central processor is provided which communicates with the measuring head for the parameter setting, status inquiry and determination of a point of disturbance. Thereby the central evaluation of the signals is made possible. In addition several measuring heads can be arranged in the zone of the planar structure and together they can carry out the evaluation of the planar structure. The different measuring heads are then evaluated in the central processor. In addition, the communication is favourable, in order to transmit, for example, the current speed values of the planar structure relative to the measuring head to said measuring heads in order to thereby be able to calculate the surface of the point of disturbance.

A device with the characteristic features of claim 20 also solves the task, beside the method according to the invention. Here several measuring heads are provided for the determination of points of disturbance in a planar structure being produced by a machine, in particular by a card. Furthermore the measuring device comprises a central processor, by which parallel and serial lines connect the measuring heads according to the invention. By these connections the communication between the measuring heads and the central processor is provided. Thereby a continuous transmission of data is possible and thus a very short response time results, for example, for an excessive number of points of disturbance.

It has proved as particularly favourable that the measuring heads, for the reporting of points of disturbance to the central processor, are being connected with the central processor via parallel lines. Through these parallel lines it is continuously signalled whether a point of disturbance is present or not. However, the signal is only then sent if it has been determined how large the point of disturbance is, i.e. only then when the point of disturbance has passed the measuring head and the photodiode again has determined a value below the threshold value. The evaluation in the measuring head and the report to the central processor are thus conveyed somewhat delayed.

For parameter setting and/or for the status inquiry of the measuring heads through the central processor, the measuring heads are additionally connected with the central processor through serial lines. Through this serial connection the measuring heads are supplied, for example, with the doffer speed at the card by the central processor, i.e. the speed of the planar structure in relation to the measuring head. In addition the measuring head is asked whether sufficient signal level is present, i.e., whether the measuring head can operate correctly at all, or whether an error is present on the part of the measuring head.

If for signal generation a photodiode array is applied in the measuring head, with single photodiodes being arranged next to each other, essentially without a gap, then an essentially thorough monitoring of the spot to be examined is possible.

If the photodiodes are essentially arranged in line next to each other, then a simple determination of the surface of the point of disturbance is possible.

To illuminate the spot to be examined in particular IR diodes have proved as favourable. If these are arranged in particular at an angle of approximately 45° in relation to the clothing points of the card, then it can, to a large extent, be excluded that, by reflections of the light on the clothing points, incorrect points of disturbance have been determined by the photodiodes. For a statistical evaluation of the condition of the planar structure it proved as sufficient, if per measuring head a photodiode array with 10 single diodes is provided.

In order to be able to perform a statistical evaluation of the quality of the planar structure, it is usually sufficient to arrange the measuring heads at a certain distance from each other over the width of the planar structure. For commonly employed cards it has proved favourable to arrange about 5 measuring heads. This means that the measuring heads have a distance of approximately 20 cm from each other.

In order to filter disturbing light from the environment of the machine and not to let it be included in the evaluation of the quality of the planar structure flow, it can be favourable to provide a daylight filter arranged in front of the diodes.

Further advantages of the invention are described in connection with the following exemplified embodiments by way of the accompanying drawing, wherein show:

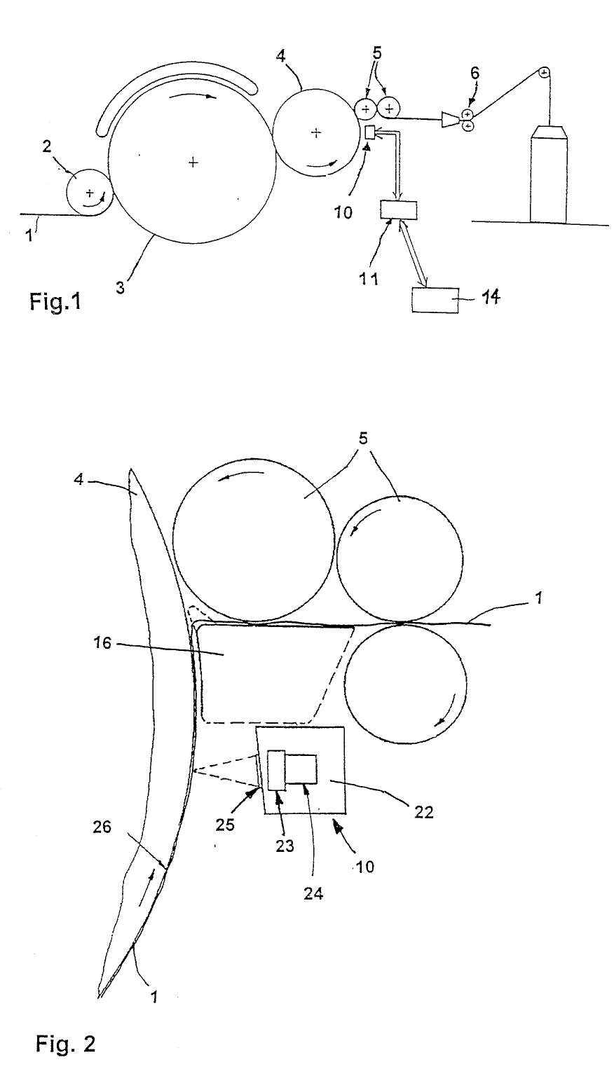

FIG. 1 a schematic illustration of the most important components of a card;

FIG. 2 a mechanism according to the invention within the zone of the doffer rollers;

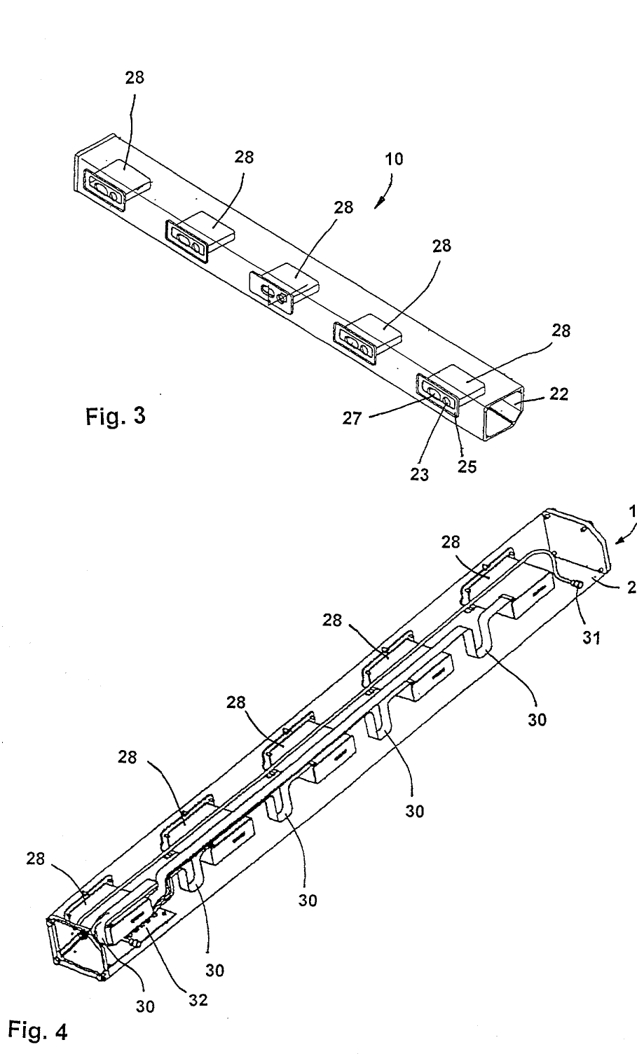

FIG. 3 a measuring bar in front view;

FIG. 4 a measuring bar in rear view;

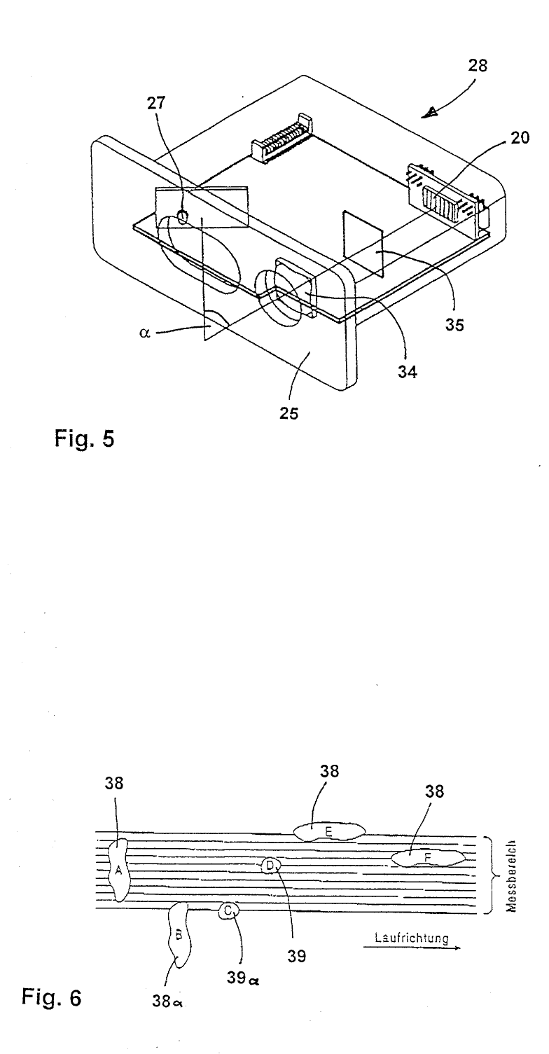

FIG. 5 a measuring head;

FIG. 6 a principle illustration of points of disturbance within the measuring zone;

FIG. 7 the camera picture of a planar structure with the pertaining measuring signals;

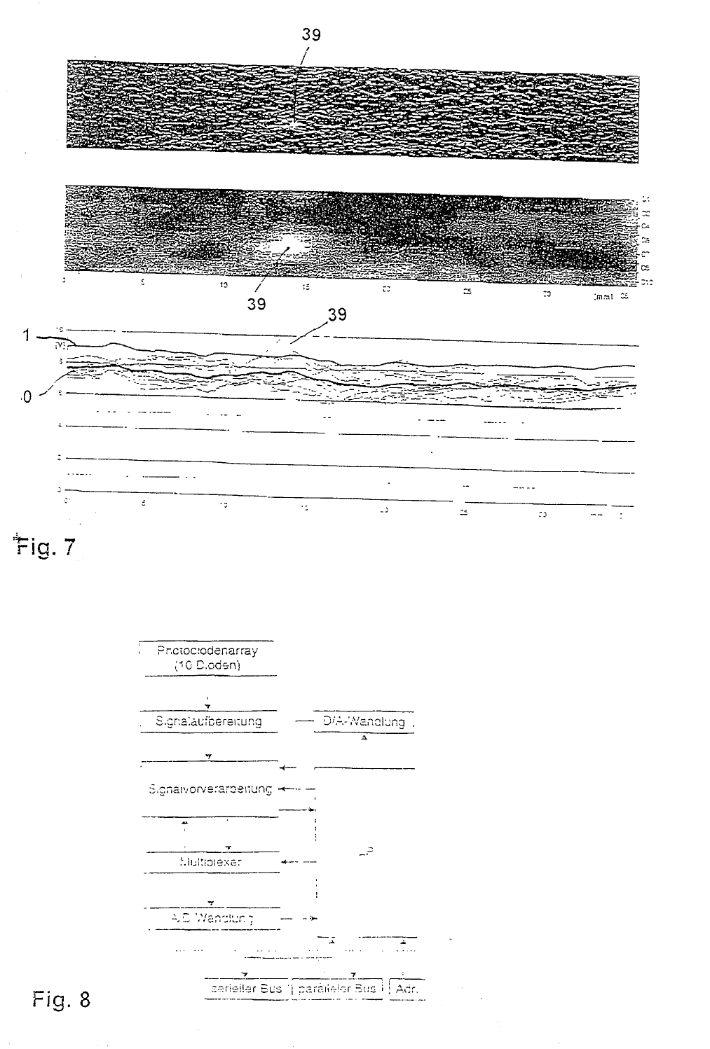

FIG. 8 an illustration of the sequence of functions of a device according to the invention;

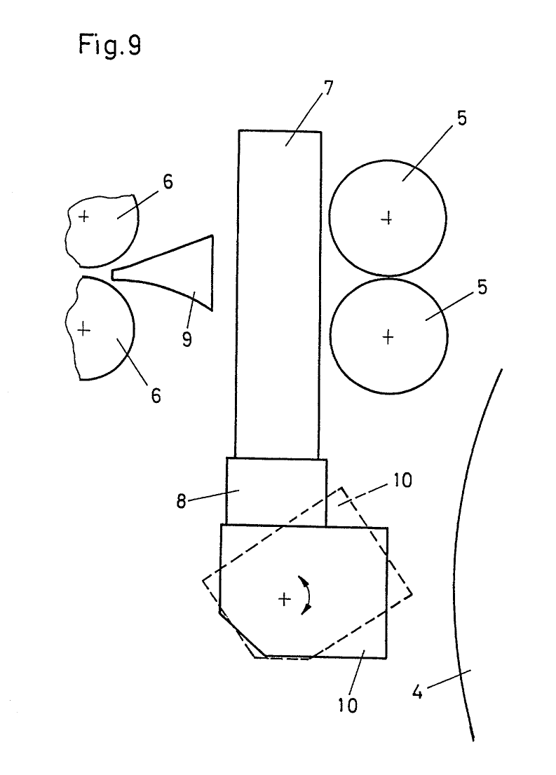

FIG. 9 a schematic illustration of a tiltable device according to the invention.

FIG. 1 shows the structure of a card on which the device according to the invention is arranged. A fibre web 1 is led over a taker-in 2 and a tambour 3 to a doffer 4 where it is taken over. In the area of this doffer 4 a measuring device according to the invention 10 is arranged before the take-up of the fibre web 1 by the take-up rollers 5. The fibre web received from the take-up rollers 5 is led out of the card via a funnel and draw-off rollers 6 and is being deposited as a roving in a can. In the measuring device 10 measuring heads 28 are arranged which by means of data lines are connected with a central processor 32. The measuring heads 28 and the central processor 32 are located in a common housing 22 and together form the measuring device 10. The central processor 32 is connected with the card control unit 11 by a field bus, for instance CAN, Profibus, Interbus, Ethrnet etc. The card control unit 11 communicates to the central processor 32 when the card is in operation and measuring is to take place. The central processor 32 supplies the card control unit 11, at regular intervals of e.g. 5 minutes, with the results of the particle count for further statistical evaluation.

The card control unit 11 can, by a further bus-system, e.g. Profibus, Ethernet, etc., be connected with a higher-ranking data system 14. The higher ranking data system 14 collects the data from all cards and if necessary from still further spinning frames and provides these for monitoring and comparison purposes.

In FIG. 2 a detail of FIG. 1 shows the area of the take-up rollers 5 and the measuring device 10. Underneath the take-up rollers 5 a guide element 16 is provided across which the fibre web is led from the doffer 4 after its take-up. Below the guide element 16 the measuring device 10, with respective measuring heads 28, is arranged. In another exemplified embodiment it would however, also be possible to provide the measuring device 10 within the area of the guide element 16 and to integrate it in said guide element. It is favourable if the measuring head is essentially directed perpendicularly toward the doffer 4 in order to be able to register the point of disturbance as undistorted as possible.

The measuring device 10 comprises a housing 22 in which an optical means 23 as well as the photo sensor elements 24 are accommodated. In front of the optical means 23 a window 25 is arranged which locks and thus protects the housing 22 against contamination. With the optical means 23 and the photo sensor element 24 a spot 26 on the doffer roller 4 is being monitored. By turning of the doffer 4 the fibre web 1 lying on the spot 26 said fibre web is thus monitored. Since a lens is arranged in the optical means 23 the spot 26 is magnified in the photo sensor element 24. Thereby a more exact collection of points of disturbance is possible in the fibre web 1 since already small points of disturbance are brought to a size, which can be registered by the photo sensor element.

In FIG. 3 a front view of a measuring device 10 is illustrated. Five measuring heads 28 are installed in the housing 22. Each of the measuring heads 28 is locked with a window 25. Behind the window 25 there is the light 27 and the optical means 23 are arranged. The housing 22 is laid-out as small as possible, so that on the one hand the installation on the card is made possible which can also be carried out later, and on the other hand, however, to have sufficient space for the single measuring heads 28 as well as for their wiring.

FIG. 4 shows a rear view of the measuring device 10, whereby for clarity reasons two outer walls of the housing 22 are omitted. The five measuring heads 28 are fastened in an outer wall of the housing 22 by means of screws. From each of the measuring heads 28 a bus cable 30, which for space reasons is provided as a flat cable, is led to a central processor 32, which is likewise fastened in the housing 22. The bus cables 30 are preferably laid in the form of loops in order to facilitate the exchange of single measuring heads 28. With the loop in the bus cable 30 it is possible to remove the single measuring head 28 far enough from the housing 22, until the plug, which connects the bus cable 30 to the measuring head 28, can be plugged out of said measuring head. Likewise a cable 31 is arranged within the housing 22 through which information, for example about the number of revolutions of the doffer 4 and thus the speed by which the fibre web 1 passes the measuring heads 28, is supplied to the central processor 32 and from there through the bus cable to the single measuring heads 28.

In FIG. 5 a measuring head 28 is illustrated in more detail. An element with the photodiodes 20 is fastened on a plate. Between the photodiodes 20 and the window 25 a lens 34 and a daylight filter 35 are arranged. By means of the lens 34 the spot 26 to be observed on the doffer roller 4 is magnified so that the photodiodes 20 receive enlargements of possible points of disturbance and that thus they can deliver a more distinct signal. By means of the daylight filter 35 stray light gets filtered which does not come from the specifically provided illuminating means. Furthermore a light 27 is located on the plate for the spot 26 to be examined. The light 27 consists of IR diodes, which are arranged at an angle α to the optical axis of the lens 34 and the photodiodes 20. In the present, exemplified embodiment the angle α amounts to 45°, whereby the light 27 is arranged laterally to the optical means. Thereby a particularly good illumination of the spot 26 results and in addition a reflection of the clothing teeth of the doffer 4 on the photodiodes 20 is avoided.

FIG. 6 shows a schematic illustration of different types of points of disturbance within a measuring zone. Each of the shown strips represents the monitoring zone of one of the photodiodes 20. In the shown exemplified embodiment there is a total of 10 such photodiodes 20. Regarding their size, the clouds 38 are illustrated as larger surfaces than the neps 39. If the measuring device according to invention is to be used for the determination of wear conditions on the card or a preceding machine then it is sufficient to determine the neps 39 only. For this it is necessary to exclude the clouds 38 with regard to the located brightness differences in relation to a certain average value and to only evaluate the neps 39. A particle of disturbance 39a could just as well be part of a cloud such as 38a and is therefore not counted.

By evaluating the signals of the photodiodes 20 in connection with the speed, by which the fibre web 1 is moved past the photodiode 20, the surface-size extent of the point of disturbance can be determined and it can be specified whether it relates then to a cloud 38 or to a nep 39. This is both possible if the clouds are directed in longitudinal direction as well as if they lie in transverse direction in relation to the measuring zone. In accordance with the above already described definition it can be favourable if only such points of disturbance are rated as neps 39 which have on the one hand a small surface-size extent and on the other hand lie entirely within the measuring zone. If a nep 39a lies at the borderline of the measuring zone, then it is favourable not to register it in the statistics as nep since it is not possible to determine the surface-size extent. The point of disturbance can either still further extend beyond the measuring zone or thus present a cloud such as 38a or it can end again directly outside the measuring zone and thus actually represent a nep 39. In order to keep counting errors as low as possible favourably it is defined that points of disturbance, which are only registered by the photodiode at the far outer end, are not being counted as neps 39.

In FIG. 7 three illustrations of a fibre web 1 are shown. In the uppermost illustration a camera picture with a point of disturbance in a cotton fibre web 1 is shown. The illustrated zone in reality extends over approximately 35 mm and is gradually scanned by the light emitting diodes 20, 10 of said diodes are arranged directly next to each other. The middle picture shows the pertaining measuring signals of the photodiodes of the upper picture in the form of brightness differences. Here it already becomes clear that there are zones that appear particularly bright and other zones that are rather dark. Within the darker zones the fibre web is thinner and thus, due to the smaller number of white fibres, less light is reflected to the photodiodes. Within the zones where the fibre web 1 is thicker more light is reflected and thus brighter zones develop that are registered by the photodiodes. Within the zone of a nep 39 a particularly high brightness value is determined. That nep 39 appears in the middle picture as a white spot.

The lower picture of FIG. 7 shows the signal pattern of the single photodiodes. From this it is evident that in particular within the zone of the nep 39 at least one photodiode shows clearly a higher amplitude. This is a typical indication for the fact that a nep 39 is present here. Besides that the distinct magnitude of brightness appears only briefly and/or only over a short zone of length of the fibre web 1, so that the evaluation of the signal here will result in the determination of a nep 39 and not a cloud 38. Beyond that from the lower picture of FIG. 7 the average value 40 derived from all the signals of the 10 photodiodes is also shown as a lower, boldly drawn line. According to the invention the average value 40 results from the individual values of the photodiodes, whereby in a preferred embodiment of the invention the average value 40 in each case is being integrated over 5 mm distance of the passing fibre web 1 and thus an average value 40 over always equally sized sections of the fibre web 1 is received. Thus, the average value is always adapted to the current values and thus causes a signal lying above the average brightness value to be included in the evaluation. As a threshold value 41 according to the bold line is taken, not the average value 40,but a threshold value 41 being, by a defined constant factor, beyond the course of the average value 40. As a favourable factor the factor of approximately 1.2 has resulted here. Only signal patterns that are above this threshold value 41 are included in the evaluation and are rated whether they relate to a nep 39 or to a cloud 38.

In FIG. 8 the principal structure as well as the course of the signal processing of a measuring head 28 are illustrated. On a photodiode array with 10 single diodes an approximately 5 mm wide zone of the doffer roller 4 of the card is shown. During the signal processing, the signals of the photodiodes are amplified individually. Afterwards, also during the signal pre-processing, the average value of the 10 signals is formed and integrated with an adjustable integration period. The integration period is set by the microprocessor and depends on the circumferential speed of the doffer roller 4 and thus on the speed by which the fibre web 1 passes the measuring device. From the average value, the pertaining threshold value is calculated in a microprocessor and is transmitted via a D/A transducer to the signal pre-processing. In the signal pre-processing the signals of the photodiodes are compared one by one with the threshold value, supplied by the microprocessor, and one digital signal each is formed which indicates whether the selected signal lies above or below the threshold value. The digital signals are then transmitted to the microprocessor.

For the monitoring of the photodiodes, e.g. to control whether a sufficiently high signal level is present, a multiplexer is applied. This device selects one of the 10 measuring signals, the average value of the measuring signals or the average value of the time and presents these to the A/D transducer and the signal pre-processing. Via the multiplexer it is thus checked whether the measuring device is still functionally correct.

As interface to a central processor 32, serial and parallel connecting lines are used. The serial lines applied for the parameter setting, e.g. transmission of the doffer speed and for the status inquiry, e.g. to determine whether a sufficiently high signal level of the measuring head is present. To each measuring head an address is assigned, so that it is identifiable and accessible accordingly. For each measuring head one line each is present in the parallel bus. Through it each measuring head indicates whether a point of disturbance is present or not. For the reason of evaluation, which must take place in the measuring head, this signal is transmitted to the central processor 32 with some delay, since the evaluation can only take place a after the point of disturbance has passed the measuring head completely.

FIG. 9 shows a device 10 according to the invention that is tiltable for cleaning purposes. The measuring device 10 is arranged on a holder which is connected with the transverse web take-up. The fibre web is taken off from the take-up rollers 5 by the transverse web take-up and merged into one fibre web. The fibre web is then led through the funnel 9 and supplied to the delivery rollers 6. The transverse web take-up 7, holder 8, funnel 9 and delivery rollers are tiltable. By arranging the measuring device on the tiltable holder this is also tiltable and in the tilted position (broken line illustration) it is accessible for cleaning. In the broken line illustration, for reasons of clarity, only the measuring device 10 is shown.

The present invention is not limited to the illustrated exemplified embodiments. It is understood that modifications of the invention are possible in particular regarding the scope of application. The sensor according to invention and the method of the evaluation can also be arranged in a mechanism that is moveable transverse to the moving direction of the fibre web.

1. Method for determining points of disturbance in planar structures, in particular from fibres, whereby, by means of at least one signal receiver, comprising photodiodes being arranged in line, determines the brightness of the planar structure and recognizes values of brightness being above a pre-determined threshold value as points of disturbance, characterized in that the planar structure is moved relative to the signal receiver and that the surface-size extent of the value of brightness, laying above the pre-determined threshold value, is being determined.

2. Method according to one of the preceding claims, characterized in that a classification of the points of disturbance takes place based on the number of responding diodes and/or the duration of the response time of the diodes.

3. Method according to one of the preceding claims, characterized in that a small surface of the point of disturbance is rated as genuine disturbing particle and a large surface of a point of disturbance as a permissible brightness fluctuation within the planar structure.

4. Method according to one of the preceding claims, characterized in that for the definition of a point of disturbance an average value and a threshold value are formed, above which the signal processing indicates a point of disturbance.

5. Method according to one of the preceding claims, characterized in that the determined average value is being multiplied by a factor and thus serves as threshold value for the determination of points of disturbance.

6. Method according to one of the preceding claims, characterized in that the average value is formed over all diodes and is then being averaged or integrated through the time.

7. Method according to one of the preceding claims, characterized in that for averaging the overall voltage of the diode signals is used.

8. Method according to one of the preceding claims, characterized in that the average value is formed over a period of time, which corresponds with a pre-determined distance, in particular, with approximately 5 mm of the planar structure.

9. Method according to one of the preceding claims, characterized in that the period of time is selected depending on the doffer speed.

10. Method according to one of the preceding claims, characterized in that each photodiode signal is examined one by one with regard to the exceeding of the threshold.

11. Method according to one of the preceding claims, characterized in that the width of the point of disturbance is determined by the number of measuring signals laying next to one another which, at the same time, exceed the threshold value.

12. Method according to one of the preceding claims, characterized in that the length of the point of disturbance is determined through the doffer speed and the time, during which the threshold value is exceeded.

13. Method according to one of the preceding claims, characterized in that the surface of the point of disturbance is determined by multiplication of the determined width and length of the point of disturbance.

14. Method according to one of the preceding claims, characterized in that the exceeding of a pre-determined surface-size, in particular 4 mm² is not rated as a point of disturbance.

15. Method according to one of the preceding claims, characterized in that, when a threshold value is exceeded by at least one of the two measuring signals from the extreme outer end of the photodiodes arranged in line, then the point of disturbance is not rated as a point of disturbance.

16. Method according to one of the preceding claims, characterized in that the signals of the signal receiver are being amplified before their evaluation.

17. Method according to one of the preceding claims, characterized in that the planar structure within the zone of the planar structure to be measured is illuminated, in particular, from the side.

18. Method according to one of the preceding claims, characterized in that the planar structure within the zone of the signal receiver is optically magnified.

19. Method according to one of the preceding claims, characterized in that a central processor and the measuring head communicate with one another for the parameter setting, status inquiry and the determination of a point of disturbance.

20. Device, in particular to carry out the method according to one of the preceding claims, with several measuring heads (28) for the determination of points of disturbance in a planar structure (1) being produced in a machine, a card in particular, characterized in that the device comprises a central processor (32), and that the measuring heads (28) are connected through serial and/or parallel data lines with the central processor (32).

21. Device according to the preceding claim, characterized in that the measuring heads (28), for reporting of points of disturbance to the central processor (32), are being connected with the central processor (32), together (as a whole) in summary via a parallel bus.

22. Device according to one of the preceding claims, characterized in that the measuring heads (28) for parameter setting and/or status inquiry are connected with a central processor (32) by way of the central processor (32) via a serial bus.

23. Device according to one of the preceding claims, characterized in that in the measuring head (28) a photodiode array is provided for signal registration, said array comprising single photodiodes (20) arranged next to each other essentially without a gap in between.

24. Device according to one of the preceding claims, characterized in that the photodiodes (20) are essentially arranged in line next to each other.

25. Device according to one of the preceding claims, characterized in that between the photodiodes (20) and the zone (26) to be imaged a lens (34) is arranged, in particular for magnifying of the zone (26) to be imaged.

26. Device according to one of the preceding claims, characterized in that illuminating means (27) are arranged, in particular IR diodes, for the illumination of the zone (26) to be imaged.

27. Device according to one of the preceding claims, characterized in that the illuminating means (27) is arranged laterally, in particular for instance at an angle of 45° in relation to the clothing points of the card.

28. Device according to one of the preceding claims, characterized in that the array of photodiodes comprises ten individual diodes (20).

29. Device according to one of the preceding claims, characterized in that over the width of the doffer (4) of the card, several, in particular five, measuring heads (28) are arranged.

30. Device according to one of the preceding claims, characterized in that in front of the photodiodes (20) a daylight filter (35) is arranged.

31. Device according to one of the preceding claims, characterized in that the measuring device (10) is tiltably arranged.
